(19) United States
(12) Patent Application Publication
(10) Pub. No.: US 2005/0138178 A1
(43) Pub. Date: Jun. 23, 2005

(54) Wireless mobility manager

(76) Inventor: Shaun Astarabadi, Laguna Niguel, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/741,028

(22) Filed: Dec. 19, 2003

(51) Int. Cl. G06F 15/16

(52) U.S. Cl. 709/227

(57) ABSTRACT

Embodiments of a wireless mobility manager and its method of operation are described. In one embodiment, the method includes a wireless station that automatically scans a current communication range to identify a first group of wireless access points. In one embodiment, scanning is performed if a signal strength of a current wireless connection to a wireless access point falls below a user selected scan threshold. Subsequently, the wireless device automatically establishes a wireless connection with a selected wireless access point from the first group of wireless access points. In one embodiment, the wireless connection is established once the current signal strength of the current wireless connection falls below a user selected switch threshold. Alternatively, the wireless station may determine quality of service (QoS) characteristics of the first group of wireless access points to select an access point.

### FIELD

Embodiments of the invention generally relate to the field of wireless communications. More particularly, one or more embodiments of the invention relate to a wireless mobility manager and its method of operation.

### GENERAL BACKGROUND

Wireless technology provides a mechanism for either replacing or extending traditional wired networks including, but not limited to, local area networks (LANS), personal area networks (PAN) and metropolitan area networks (MAN). Using radio frequency (RF) or non-RF technology, wireless networks transmit and receive data over the air, through walls, ceilings and even cement structures without wired cabling. For example, a wireless LAN (WLAN) is a flexible data communication system that provides all the features and benefits of traditional LAN technology, such as Ethernet and Token Ring, but without the limitations of being tethered together by a cable. This provides increased freedom and flexibility.

In other words, a WLAN is a network in which a mobile user can connect to a local area network (LAN) through a wireless (radio) connection according to a wireless protocol. Wireless protocols include, but are not limited to IEEE 802.11 (e.g., IEEE 802.11a, 802.11b, 802.11g), HiperLAN (e.g., HiperLAN1, HiperLAN2, etc.), or any other wireless communication protocol. These wireless protocols are designed to provide high bandwidth allocation at a relatively low cost, without the need for substantial rewiring of various structures.

Mobility is a major motivation for deploying a wireless network. This mobility allows devices to move while connected to the network and transit frames while in motion. However, the mobility provided by wireless networks is restricted by several constraints. For example, wireless networks are implemented at the link layer, and therefore, are limited to providing link layer mobility. By way of contrast, the Internet protocol (IP) affords the network designer no such luxury. Although wireless devices can freely move within a network, IP, as it is currently deployed, provides no way to move across subnet boundaries.

In other words, one current requirement for mobility of a wireless device is that the IP address of the wireless device can not change when connecting to any of the access points. Accordingly, all wireless devices must remain on the same subnet. As long as the wireless device stays on the same IP subnet, it does not need to re-initialize its network stack and it can keep its transmission control protocol (TCP) connections open. However, if the wireless device leaves the subnet, the device is required to get a new IP address and re-establish any open connection.

Accordingly, wireless device mobility is limited to various access points within a single subnet. Furthermore, as the wireless device moves between the various access points of the single IP subnet, the wireless device must perform an authentication and association procedure with a new subnet access point. Therefore, as the wireless device roams within the subnet, the user must know and manually enter a Wired Equivalence Privacy (WEP) key in order to switch between access points of the subnet to maintain communication with the subnet. This increases the amount of user activity required to roam within a subnet.

### BRIEF DESCRIPTION OF THE DRAWINGS

The various embodiments of the present invention are illustrated by way of example, and not by way of limitation, in the figures of the accompany drawings, and in which:

FIG. 1 is a block diagram illustrating a communication system, including one or more wireless stations having a wireless mobility manager, in accordance with one embodiment of the invention.

FIG. 2 is a block diagram further illustrating a wireless station of FIG. 1, in accordance with the further embodiment of the invention.

FIG. 3 is a diagram illustrating a user interface of a wireless station for setting switch and scan thresholds, in accordance with one embodiment of the invention.

FIG. 4 is a diagram illustrating a user interface screen of a wireless station for selection of a communications interface, in accordance with one embodiment of the invention.

FIG. 5 is a block diagram further illustrating the communication system of FIG. 1 to show wireless station subnet roaming, in accordance with one embodiment of the invention.

FIG. 6 is a flowchart illustrating a method for providing a continuous wireless connection according to a user selected SCAN THRESHOLD and to a user selected SWITCH THRESHOLD, in accordance with one embodiment of the invention.

FIG. 7 is a block diagram illustrating a method for downloading an access point list to enable access point scanning, in accordance with one embodiment of the invention.

FIG. 8 is a flowchart illustrating a method for establishing a wireless connection with the selected access point, in accordance with one embodiment of the invention.

FIG. 9 is a flowchart for establishing a wireless connection with a selected access point to provide a pre-allocated bandwidth to a wireless station, in accordance with one embodiment of the invention.

FIG. 10 is a flowchart illustrating a method for wireless station roaming from an access point of a first network to a selected access point of a second network, in accordance with one embodiment of the invention.

FIG. 11 is a flowchart illustrating a method for scanning for selected access points of a second network, in accordance with one embodiment of the invention.

FIG. 12 is a flowchart illustrating a method for detecting one or more access points of a second network, in accordance with one embodiment of the invention.

FIG. 13 is a flowchart illustrating a method for establishing a wireless connection with a selected access point of a second network, in accordance with one embodiment of the invention.

### DETAILED DESCRIPTION

Embodiments of the invention generally relate to a wireless mobility manager and its associated operation as described herein. In one embodiment of the invention, a wireless mobility manager monitors the signal quality of a current wireless connection to a wireless access point. Without user intervention, a scan may be conducted to identify one or more wireless access points within a current communication range when the signal quality of the current wireless connection falls below a SCAN THRESHOLD. The signal quality may be based on signal strength, signal-to-noise ratio (SNR), error rate, connection count or the like. The SCAN THRESHOLD may be either a preset value or a programmable value that is set by the user.

Once scanning is complete, the wireless mobility manager determines whether the signal quality of the current wireless connection falls below a SWITCH THRESHOLD, either a preset value or a programmable value that is set by the user and normally less than the SCAN THRESHOLD. If so, the wireless mobility manager allows the wireless station to establish a new wireless connection with another wireless access point selected from the one or more identified access points. This “handoff” is conducted without user intervention as well.

According to another embodiment of the invention, the wireless station, having a wireless connection with an access point of a first network, roams into communication range of a second network. Once the wireless station roams into communication range of the second network, the wireless station establishes a wireless connection with a selected access point of the second network. In one embodiment of the invention, the wireless mobility manager of the wireless station determines a signal strength of one or more access points of the second network. In addition, the wireless station may determine various quality of service (QoS) characteristics of the identified access points in order to select an access point based on signal strength and/or QoS characteristics. Hence, the user of the wireless station experiences a quality of service from the selected access point, which is roughly equivalent to the level of service provided by a current wireless connection while experiencing a continuous wireless network connection without requiring user intervention.

In the following description, certain terminology is used to describe features of the invention. For example, the term “group” represents one or more. The term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

An example of “software” includes executable code in the form of an application, an applet, a routine or even a series of instructions. The software may be stored in any type of machine readable medium such as a programmable electronic circuit, a semiconductor memory device inclusive of volatile memory (e.g., random access memory, etc.) and/or non-volatile memory (e.g., any type of read-only memory “ROM,” flash memory), a floppy diskette, an optical disk (e.g., compact disk or digital video disk “DVD”), a hard drive disk, tape, or the like.

The term “wireless station” or “station” is used to refer to a portable device adapted to receive and/or transmit wireless data. Examples of a wireless station include, but are not limited to a computer, a personal digital assistant (PDA), a wireless appliance, or any other portable device configured to communicate via a wireless communications medium such as, for example, radio frequency (RF) waves.

Furthermore, as described herein, the term “access point” or “AP” is an electronic device that provides a connection between one or more wireless stations and a network such as the wired interconnect. According to one embodiment, the connection is bi-directional although this bi-directional connection is not a requirement.

I. System Architecture

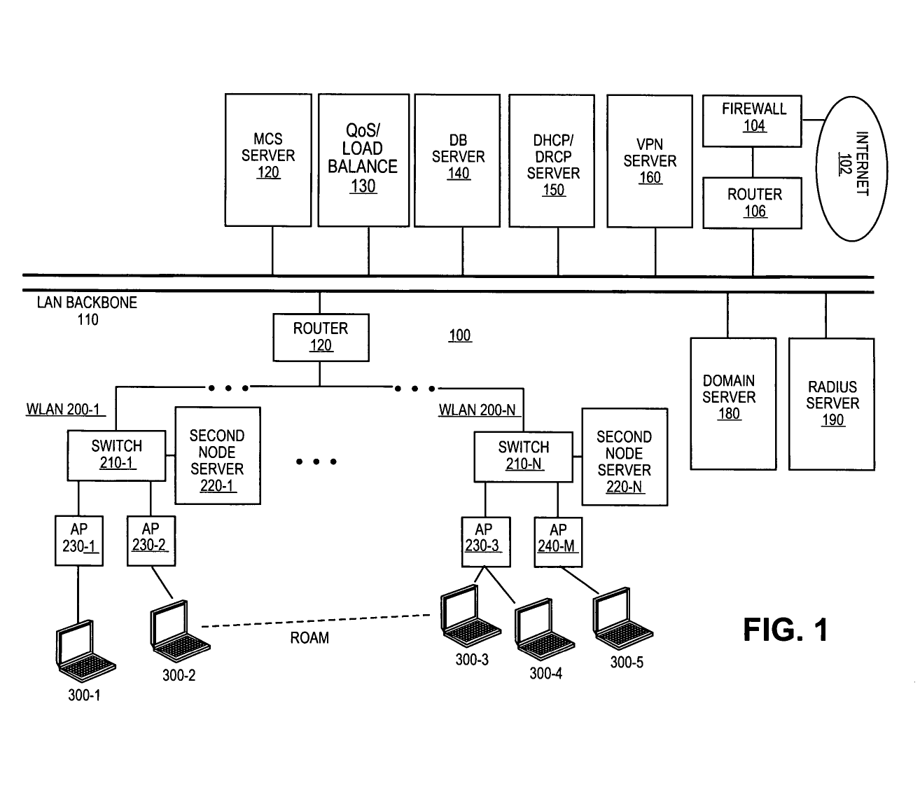

FIG. 1 is an exemplary block diagram illustrating a mobility communications system 100 with a wireless station roaming from a first network (or first subnet) to a second network (or a second subnet). According to one embodiment of the invention, mobility communications system 100 comprises a local area network (LAN) backbone 110. LAN backbone 110 is a wired interconnect (e.g., one or more electrical wires, cable, optical fiber, etc.) that establishes communications with a wide area network (WAN), such as the Internet 102 for example, via a router 106 and a firewall 104.

A virtual private network (VPN) server 160 may be included in the mobility communications system 100 to provide security and encryption/decryption capabilities to the system 100 utilizing, for example, the IP Security (IPSec) protocol. A remote authentication dial-in user service (RADIUS) server 190 may be included in mobility communications system 100 to provide authentication and accounting of users of the system 100. Other authentication protocols and server systems may be implemented as well, and integration with other authentication protocols, such as the Diameter protocol, for example, may be implemented. Furthermore, a domain server 180 may be included in mobility communications system 100 to facilitate access to and from the Internet 102 via router 106.

Herein, as an example, one or more wireless local area networks (WLAN) 200 are coupled LAN backbone 110. Such coupling may be accomplished by multiple routers or a single router 170 as shown. In one embodiment of the invention, each WLAN 200 comprises a switch 210 that is coupled to a node server 220. Although generally referenced as WLAN 200, switch 210 and node server 220, each of these elements are separately and specifically represented as WLAN 200-1 . . . WLAN 200-N (N≧1), switch 210-1 . . . switch 210-N, and node server 220-1 . . . node server 220-N, respectively. Each WLAN 200 also comprises one or more access points (AP) 230 (e.g., AP 230-1, . . . , AP 230-M, where M≧1).

More specifically, WLAN 200-1 is being accessed by wireless stations 300-1 and 300-2. In this illustrated embodiment, for example, wireless station 300-1 accesses WLAN 200-1 via AP 230-1. Likewise, wireless station 300-2 accesses WLAN 200-1 via AP 230-2. Herein, both APs 230-1 and 230-2 are represented as being part of the same subnet. A different WLAN, namely WLAN 200-N, provides a similar configuration to WLAN 200-1.

Prior to communicating data, wireless stations 300 establish an association with their corresponding APs 230. After an association is established, wireless stations 300 and APs 230 exchange data. In the infrastructure mode, the wireless stations 300 associate with an access point. The association process is a two step process involving three states: (1) “unauthenticated and unassociated”; (2) “authenticated and unassociated”; and (3) “authenticated and associated”. To transition between the states, the communicating parties exchange messages called management frames. In operation, all APs transmit a beacon management frame at a fixed interval.

As an example, to associate with an AP 230-2 and join a wireless network, a wireless station 300-2 listens for beacons to identify APs within its communication range. After identifying AP 230-2, the wireless station 300-2 and the AP 230-2 may perform a mutual authentication by exchanging several management frames as part of the process. After successful authentication, the wireless station 300-2 moves into the second state, authenticated and unassociated. Moving from the second state to the third and final state, authenticated and associated, involves the wireless station 300-2 sending an association request frame and the AP responding with an association response frame.

In one embodiment of the invention, mobility communications system 100 may be configured as an enterprise network with various APs throughout the floors of the building or different buildings and surroundings forming a corporate campus. APs 230 communicate with wireless stations 300 via radio frequency waves, such as, for example, according to an IEEE 802.11 protocol, a HiperLAN protocol or the like. Unfortunately, as wireless station 300-2 roams, association with a detected AP of a WLAN or subnet may be prohibited without wireless station 300-2 having some form of authentication information to enable association with a selected AP. In one embodiment, a wireless station 300-2 may roam from WLAN 200-1 to WLAN 200-N, while maintaining a continuous wireless connection to mobility communications network 100 without requiring any user intervention.

In one embodiment of the invention, a continuous wireless connection is enabled by downloading an AP list to which a user of wireless station 300-2 has user access privileges. Accordingly, as a user roams throughout mobility communications network 100, wireless station 300-2 maintains a connection with network 100 without requiring user intervention. In one embodiment of the invention, mobile communications (MCS) server 120 is configured to provide a wireless station, upon initial login, with an AP list that contains each AP to which a user of the wireless station has access privileges.

According to conventional techniques, wireless AP switching, which may be referred to herein as “AP hand off” is generally not performed by a wireless station until a signal level of the station is unusable. Furthermore, conventional techniques prohibit a wireless station from roaming from a first subnet, such as WLAN 200-1, to a second subnet, such as WLAN 200-N, since an Internet protocol (IP) address assigned to the wireless station will not allow the wireless station to function within the second subnet without requesting assignment of a new IP address. Furthermore, wireless AP switching does not generally enable voice communication since bandwidth pre-allocation for quality of service (QoS) or load balancing is not provided via conventional techniques.

Accordingly, in one embodiment of the invention, wireless stations 300 are configured to include a wireless mobility manager (WMM), which functions in conjunction with MCS server 120, as well as QoS/load balance server 130, to enable wireless AP scan and subsequent AP switching. This provides the user with a continuous wireless connection to mobility communications network 100 without user intervention.

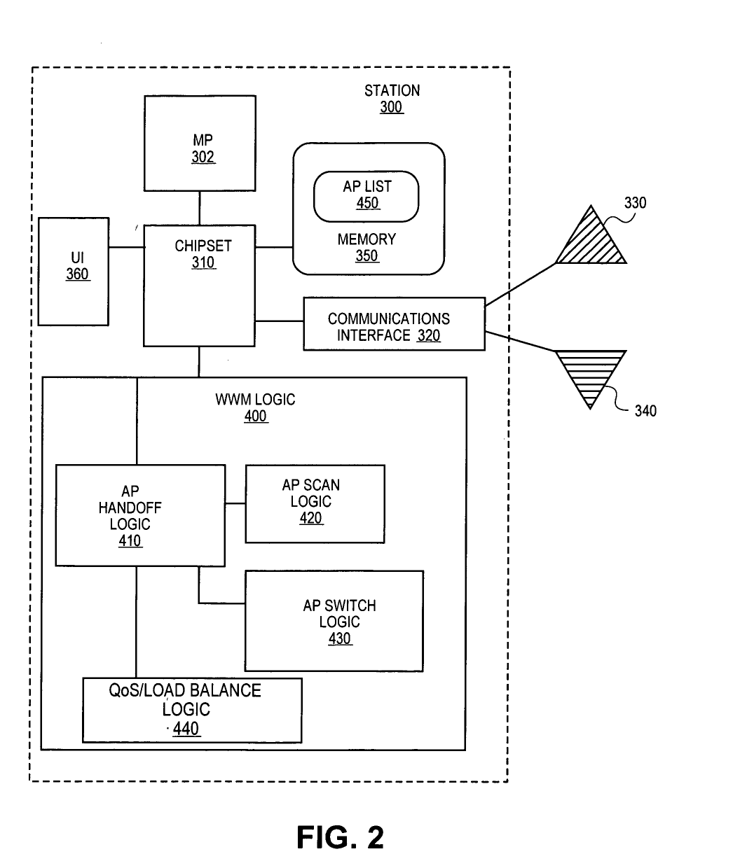

Moreover, a dynamic host configuration protocol (DHCP) and/or a dynamic rapid configuration protocol (DRCP) server 150, also connected LAN backbone 110, are configured to assign IP addresses to the nodes of mobility communications network 100, as well as an IP address for subnet roaming. Accordingly, in one embodiment, wireless stations 300 are configured, as is depicted with reference to FIG. 2.

Referring now to FIG. 2, an exemplary embodiment of wireless station 300 is shown. Herein, wireless station 300 comprises a processor (MP) 302 in communication with wireless mobility manager (WMM) logic 400 via a chipset 310. MP 302 and WMM logic 400 collectively operate to perform signal analysis, association, handoff and other operations. The chipset 310 is further coupled to a communications interface 320, a memory 350 (e.g., persistent memory such as the registry) and user interface logic 360 as described below.

As illustrated, wireless station 300 may download an AP list 450, which includes one or more APs (and perhaps stations) of, for example, each node or subnet of mobility communications system 100 (FIG. 1). In one embodiment, AP handoff logic 410 of WMM logic 400 retries a list of member APs from the MCS server 120 (FIG. 1), via a secure socket (SDL), authenticated simple object access protocol (SOAP) connection. According to one embodiment of the invention, the AP list 450 may be stored in an encrypted format based on the user's shared secret (e.g., MCS password). The user's shared secret is never stored on the station 300.

In one embodiment of the invention, AP list 450 may comprise, for example, a data structure, as depicted with reference to Table 1. This differs from conventional wireless AP switching which requires user intervention to provide a name (SSID) and to manually enter a wired equivalence privacy (WEP) key before the user's wireless station associates with a selected AP. Conversely, AP list 450 provides the necessary information to wireless station 300 to enable automatic association with any member APs, via communications interface 320, without requiring any user intervention.

TABLE 1

| | | AP | | |
|---|---|---|---|---|
| | | Authenti- | | |
| | AP | cation | AP | Subnet |
| AP | MAC | Informa- | IP | IP |
| SSID | Address | tion | Address | Address |
| ITSUM01 | 00022D38100c | Secret 1 | 172.24.13.200 | 172.24.13.201 |

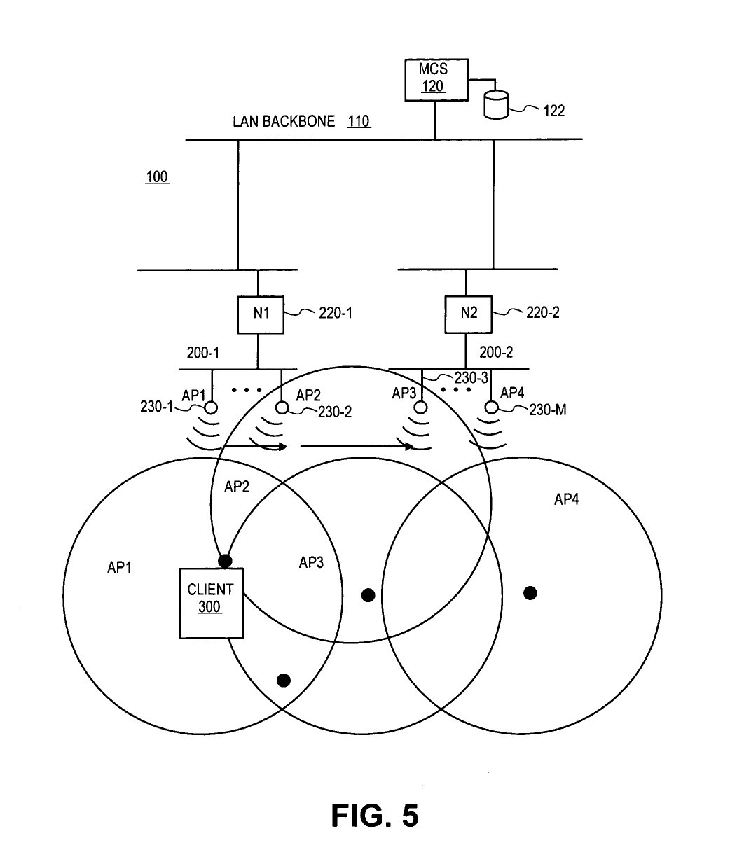

In one embodiment of the invention, the wireless station switching described herein is supported by WMM logic 400. As illustrated, AP handoff logic 410, in one embodiment, includes or operates in conjunction with AP scan logic 420. AP scan logic 420 uses a user selected SCAN THRESHOLD, which is compared to, for example, a signal strength of a current wireless connection to an AP by wireless station 300. In one embodiment, when the signal strength of the current wireless connection falls below the SCAN THRESHOLD, AP scan logic 420 will utilize AP list 450 to identify one or more APs within the communication range of the station, for example, as illustrated with reference to FIG. 5.

In one embodiment, scan logic 420 uses a wireless media access control (MAC) address to identify AP membership regarding one or more identified APs. Accordingly, WMM logic 400 operation is possible even if the APs do not broadcast their service set identity (SSID) identifier for security reasons, and it is also possible to have multiple APs with the same SSID operational as well. Therefore, a correct wireless MAC address and SSID for each AP is entered into an AP database (not shown). Usually, the MAC address is found on a label on the back of the wireless AP. Accordingly, AP list 450 comprises at least an SSID and a MAC address for each listed AP.

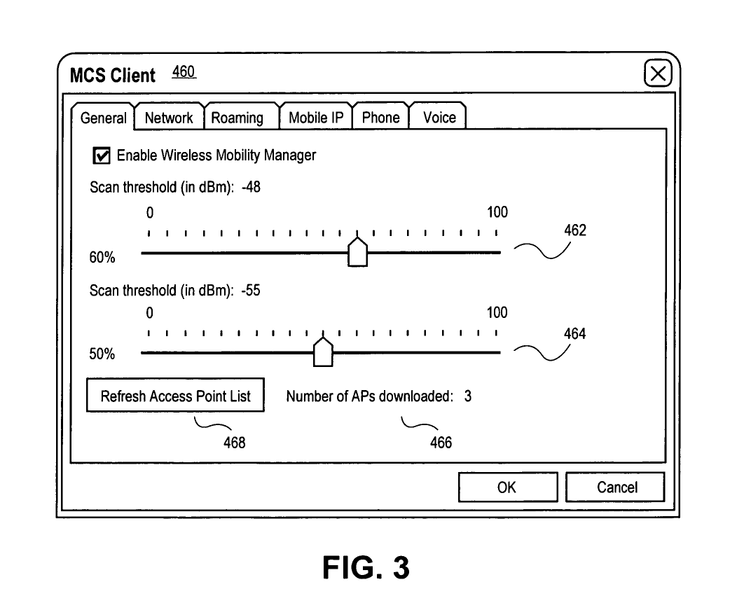

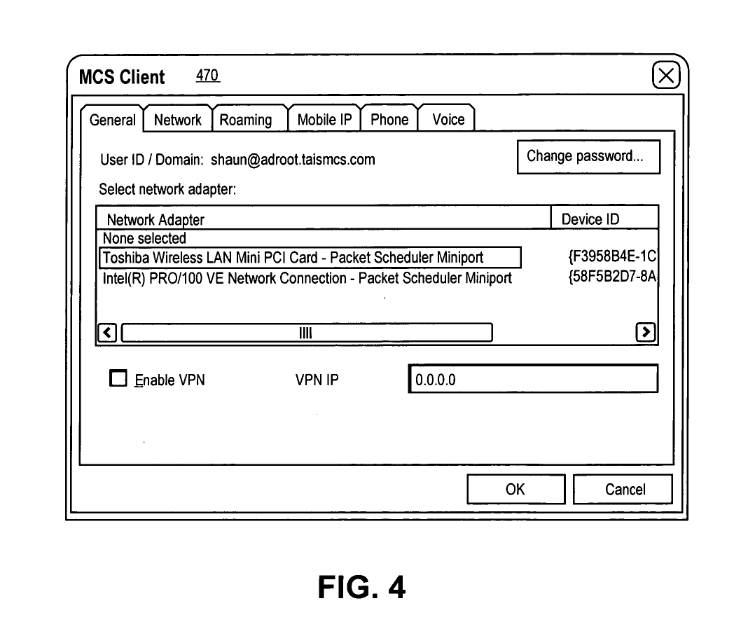

Once AP scan logic 420 identifies one or more available APs, AP switch logic 430 further monitors the current wireless connection of the wireless station to determine whether a signal strength of the current wireless connection falls below a user selected SWITCH THRESHOLD. When such is the case, AP switch logic 430 selects one of the identified APs and performs an authentication and association procedure with the selected AP. In one embodiment, the SCAN THRESHOLD, as well as the SWITCH THRESHOLD, are provided by a user via user interface (UI) 360, which is further illustrated with reference to FIGS. 3 and 4.

As illustrated in FIG. 3, in one embodiment, MCS station screen 460 allows a user to enable WMM logic 400 (FIG. 2). Once enabled, the user provides a SCAN THRESHOLD value as well as a SWITCH THRESHOLD value. These values may be selected from a group of predetermined values 462 and 464 (e.g., selected by slide bar or pull-down menu) or may be keyed in by the user. According to this illustrated embodiment, the SCAN THRESHOLD is set to −48 dBm, while the SWITCH THRESHOLD is set to −55 dBm.

Furthermore, screen 460 comprises a field 466 that indicates the number of currently available APs within the AP list. Also, screen 460 further comprises a user selection button 468. According to one embodiment, when selected, the user selection button 468 automatically refresh a current AP list from MCS server 120 of FIG. 1 for example. According to another embodiment, when selected, the user selection button 468 enables the user to update the current AP list and/or select a period of time when the current AP list will be updated automatically. The period of time, along with the SCAN THRESHOLD and SWITCH THRESHOLD values and path information for accessing AP list, may be stored in persistent memory of wireless station 300, such as the registry of wireless station 300.

FIG. 4 further illustrates another MCS station screen 470, which allows a user to select between available network access adapter cards once the user logs into, for example, MCS server 120 of FIG. 1. For this embodiment, a wireless station may include multiple adapter cards. As such, in the embodiment, AP handoff logic 410 may further analyze identified APs to detect not only APs but other connection points, which may be compared to available wireless station adapter cards. WMM logic 400 switches between available connection points to, for example, reduce costs to a user to maintain continuous wireless/wired connection to, for example, mobility communications network 100 of FIG. 1.

Referring back to FIG. 2, AP handoff logic 410 includes or operates in conjunction with quality of service (QoS)/load balance logic 440. In such an embodiment, wireless station 300 may request, for example, from a node server 220, a connection count to each identified AP. This connection count may be used in conjunction with a signal strength of the detected AP. For instance, wireless station 300-2 may request a connection count and bandwidth from MCS server 120 (FIG. 1). Alternatively, the connection count may be merely used to compute available bandwidth of each detected AP. Thus, AP handoff is based on how congested the detected AP is or may be in the future.

In a further embodiment, wireless station 300-2 may request, for example, from node server 220-1 and/or QoS/load balance server 130, pre-allocation of a certain bandwidth from an available AP. QoS/load balance server 130 attempts to pre-allocate the selected bandwidth from an AP. Once server 130 assigns an AP with the requested bandwidth, QoS/load balancing server 130 provides AP handoff logic 410 with the selected AP, in addition to any connection information required to perform association and authentication with the selected AP.

Accordingly, referring to FIG. 5, mobility communications network 100 is shown to illustrate the communication range of APs 230-1, 230-2, 230-3 and 230-M. As wireless station 300 roams within communication range of an AP, this action may or may not cause the signal strength of the wireless station to diminish. However, as the wireless station moves further away from a current wireless connection to an AP, its signal strength will diminish below the SCAN THRESHOLD, which will initiate scanning for additional APs.

For example, as illustrated, wireless station 300 will detect AP2 230-2, as well as AP3 230-3. As illustrated, wireless station 300 is currently connected to AP1 230-1. Furthermore, AP2 230-2 is a member of the same subnet as AP1. Conversely, AP3 230-3 is a member of second subnet 200-2. As such, in order to perform association and authentication with AP3 230-3, wireless station may query AP list 450. However, in order to continue uninterrupted data communications, wireless station 300 is required to use a new IP address for communications within subnet 200-2.

According to one embodiment of the invention, MCS server 120 pre-requests a temporary IP address for wireless station 300, which is included within AP list 450 corresponding to AP3 230-3 and AP4 230-M. In an alternative embodiment, wireless station 300 detects that AP3 230-3 is on a different subnet (“new subnet detection”) and requests an IP address to enable communication within the second subnet 200-2. In one embodiment, new subnet detection is performed by evaluating the following conditional expression:
(mask & AP IP)=? (mask & current IP) (1)

In one embodiment, if evaluation of the conditional expression (1) returns a true value, the wireless station 300 and AP are on the same subnet. Otherwise, the AP and wireless station 300 are on different subnets. Hence, wireless station 300 requires a new IP address to communicate within the subnet of the AP. Accordingly, in one embodiment, wireless station 300 either utilizes a pre-allocated IP address from MCS server 120 or requests an IP address from, for example, DHCP/DRCP server 150, for communication within subnet 200-2.

In one embodiment, wireless station 300 utilizes session initiation protocol mobile (SIP-M) for voice communications (packet based) and utilize the mobile Internet protocol (mobile IP) for data communications. Representatively, mobile IP permits a wireless station to move from one network link (or subnet) to another without interrupting data communications. Accordingly, as illustrated with reference to FIG. 5, wireless station 300 may associate with AP3 230-3 without interrupting communications by utilizing mobile IP. Accordingly, inter-domain roaming is performed, for example, using a pre-allocated subnet IP address, a requested IP address or mobile IP. Procedural methods for implementing embodiments of the invention are now described.

II. Operations

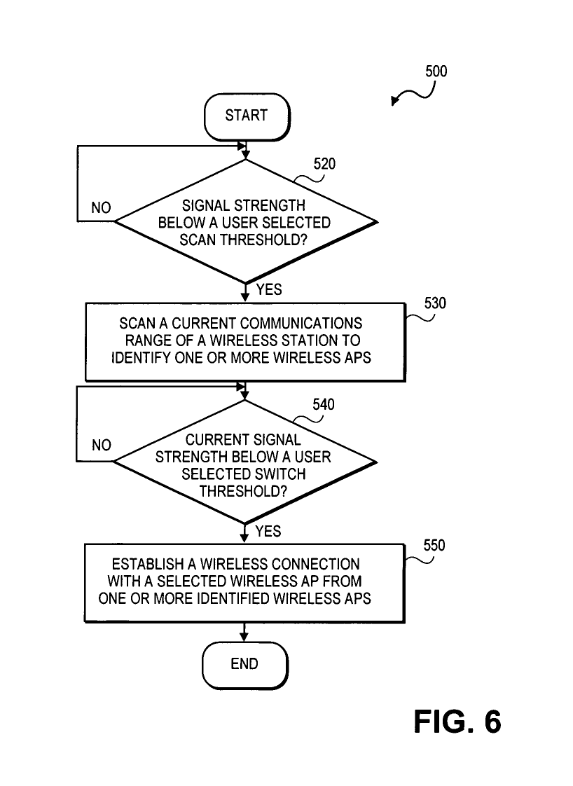

FIG. 6 is an exemplary flowchart illustrating a method 500 by which the wireless mobility manager of the wireless station initiates wireless access point (AP) handoff, in accordance with one embodiment of the invention. At process block 520, a wireless station determines whether a signal strength of the current wireless connection to a wireless AP is below a user selected SCAN THRESHOLD. When such a condition is detected, at process block 530, the wireless station begins scanning a current communication range to identify one or more wireless APs, for example, as illustrated with reference to FIG. 5.

In one embodiment, in order to reduce the performance impact of the wireless mobility manager (WMM) functionality described herein, the wireless station may discontinue scanning if the current signal strength rises above the user selected SCAN THRESHOLD, which are provided by adjustment via the user interface.

At process block 540, the wireless station determines whether the current signal strength of the current wireless station connection falls below a user selected SWITCH THRESHOLD. In the embodiments illustrated, the SWITCH THRESHOLD represents a weaker or less powerfull signal than the user selected SCAN THRESHOLD. In one embodiment, the SWITCH THRESHOLD is selected to avoid interruption of wireless communication, but below which such communication may be interrupted. Accordingly, at process block 550, the wireless station establishes a wireless connection with the selected AP from the one or more identified APs.

In the embodiment described in FIG. 6, the selection of an AP may be purely based on a signal strength of the identified wireless APs during the wireless station scan. A wireless AP, which provides a highest signal strength, is selected. As an alternative embodiment, however, the wireless mobility manager may request (i) a connection count for each identified AP (e.g., from a node server connected to the AP) and/or (ii) a bandwidth from a QoS/load balance server. As such, the wireless station may make a selection of a new AP based on the connection count, the bandwidth and/or the signal strength of each identified AP.

In another embodiment of the invention, the selection of a new AP may be prompted and/or based on a signal-to-noise ratio, which is determined for each identified AP. As such, for voice, as well as certain data communications such as streaming media for example, identified APs may exhibit sufficient signal strength while exhibiting unacceptable signal-to-noise ratios.

Likewise, the selection of a new AP may be prompted and/or based on a bit error rate of each identified AP. This measurement would likely be used for wireless stations supporting voice communications, which generally should not be perform by an AP which exhibits a significant bit error rate.

In yet another embodiment of the invention, the selection of a new AP may be prompted and/or based on a relative signal strength (RSS) slope computation. The RSS slope computation, which measures the rate of degradation of signal strength between the wireless station and the current AP, is computed as the ratio between the previously measured signal strength and the current measured signal strength.

For instance, as one example, when the measured signal strength of the current wireless connection falls below the SCAN THRESHOLD and RSS slope computation is less than a predetermined value, which may be preset or set by the user, the wireless mobility manager prompts the wireless station to scan and identify APs in its communication range. This avoids repeatedly scan operations when the signal strength oscillates around the SCAN THRESHOLD.

Alternatively, as a second example, when the RSS slope computation is less than the predetermined value, the wireless mobility manager prompts the wireless station to scan and identify APs in its communication range. This avoids loss of a connection where the signal strength quickly degrades.

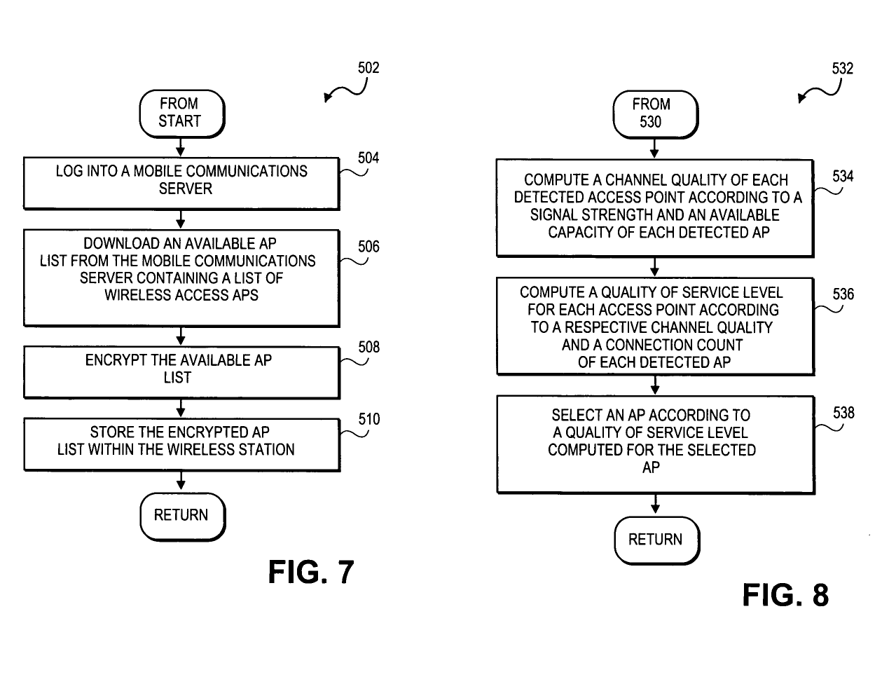

FIG. 7 is a flowchart illustrating a method 502, which is performed prior to scanning of the current communication range as set forth by process block 530. At process block 504, a wireless station logs into a MCS server as depicted in FIG. 1. Once authenticated by the MCS server, the wireless station may download an available AP list, which includes a list of APs to which a user of wireless station is an authorized member. Once downloaded, the wireless station may encrypt the available AP list (process block 508) and store the encrypted AP list in internal memory (process block 510).

FIG. 8 is a flowchart illustrating an exemplary method 532 for selecting an AP once one or more APs are identified at process block 530. At process block 534, a channel capacity of each detected AP is computed according to a signal strength and an available bandwidth of each detected AP. At process block 536, a quality of service (QoS) level is computed for each AP according to the respective channel quality of each detected AP and a connection count of each detected AP. Finally, at process block 538, an AP is selected according to the QoS level computed for the selected AP. In one embodiment, the QoS level is computed using QoS/load balance logic 440 of FIG. 2.

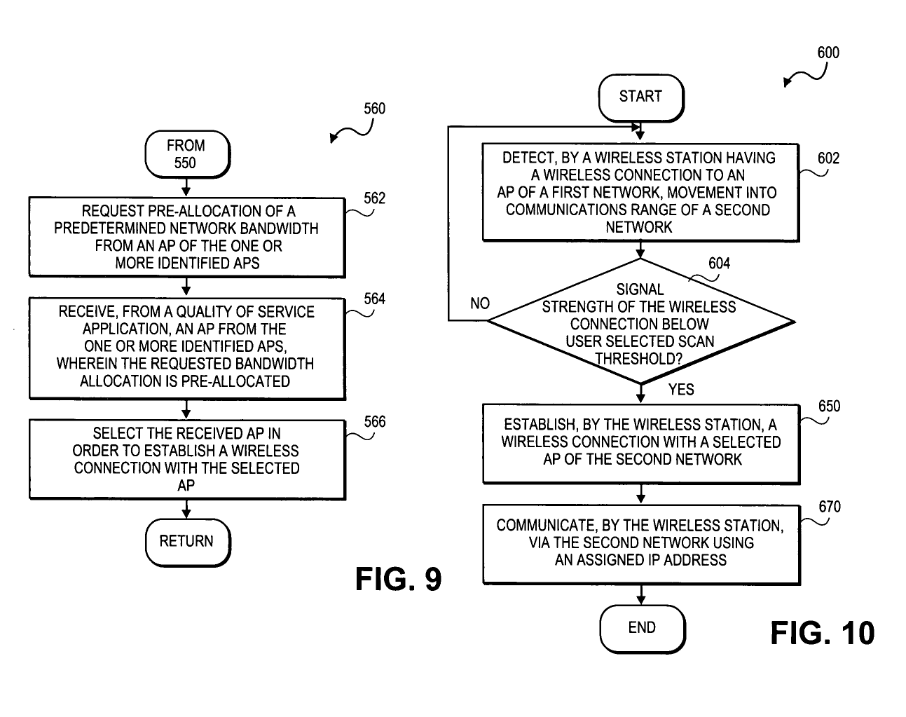

FIG. 9 is a flowchart illustrating a method 560 for establishing a wireless connection of process block 550 of FIG. 6, in accordance with one embodiment of the invention. At process block 562, a wireless station requests pre-allocation of a predetermined network bandwidth from an AP of one of the one or more identified AP. In one embodiment, this may be performed by accessing QoS/load balance server 130, which pre-allocates the bandwidth with an AP within communication network 100. Alternatively, a node server 220 may perform the pre-allocation via a coupled AP. At process block 564, the wireless station receives an AP from the one or more identified point wherein the requested bandwidth allocation is pre-allocated. At process block 566, the wireless station associates with the received AP to establish a wireless connection. Representatively, voice communications may be performed or maintained with the selected AP by utilizing the requested bandwidth allocation to assure a minimum bandwidth of, for example, 64 kilobits per second (kb/s).

FIG. 10 is an exemplary flowchart illustrating a method 600 for wireless station roaming from a first network to a second network, in accordance with one embodiment of the invention, for example, as illustrated with reference to FIG. 5. At process block 602, a wireless station having a wireless connection to an AP of a first network detects movement into communication range of a second network. At process block 604, the wireless station may detect that a signal strength of the wireless connection is below a user selected SCAN THRESHOLD. Hence, at process block 610, the wireless station scans a current communication range of the wireless station to detect one or more wireless APs of the second network. At process block 650, the wireless station establishes a wireless connection with a selected AP of the second network. At process block 670, the wireless station begins communication via the second network using an assigned IP address.

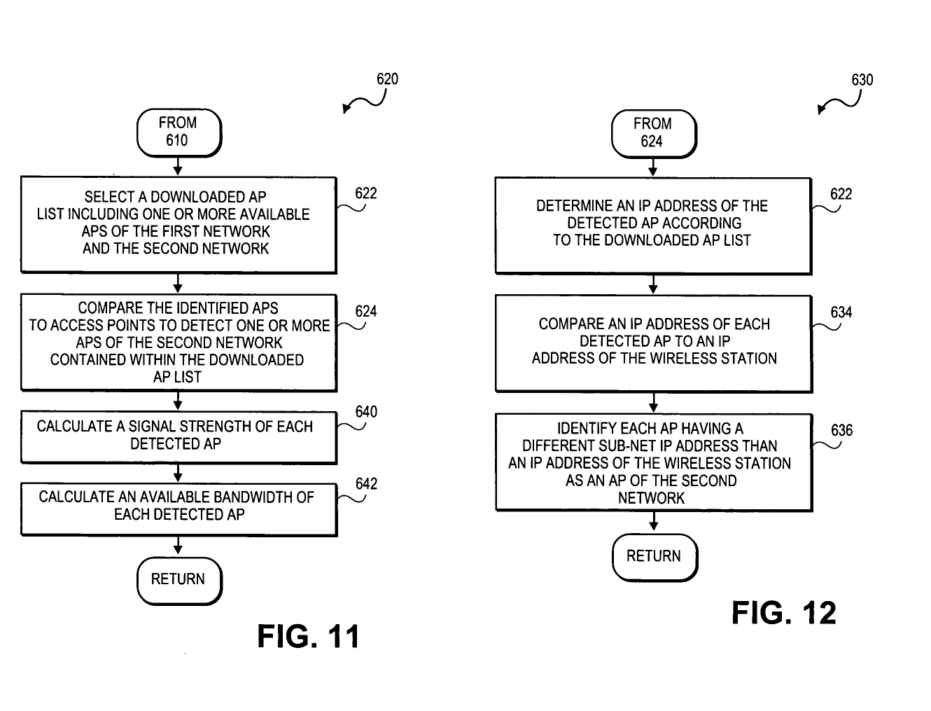

FIG. 11 is an exemplary flowchart illustrating a method 620 for performing scanning of process block 610 of FIG. 10, in accordance with one embodiment of the invention. At process block 622, the wireless station selects a downloaded AP list, including one or more available APs of the first network and the second network. At process block 624, the wireless station compares the identified APs to APs of the downloaded AP list to detect one or more APs of the second network. At process block 640, the wireless station calculates the signal strength of each detected AP of the second network. At process block 642, the wireless station calculates an available bandwidth, as well as a connection count, of each AP of the second network. Representatively, the signal strength, available bandwidth and connection count can be utilized by the wireless station to select and establish a wireless connection with an AP of the second network.

FIG. 12 is an exemplary flowchart illustrating a method for detecting wireless APs of the second network of process block 624 of FIG. 11, in accordance with one embodiment of the invention. At process block 632, the wireless station determines an IP address of the detected APs according to the downloaded AP lists. At process block 634, the wireless station compares an IP address of each detected AP to an IP address of the wireless station. At process block 636, the wireless station identifies each AP having a different subnet address than an IP address of the wireless station as an AP of the second network. Representatively, the wireless station selects between detected APs of the second network to establish a wireless connection thereto.

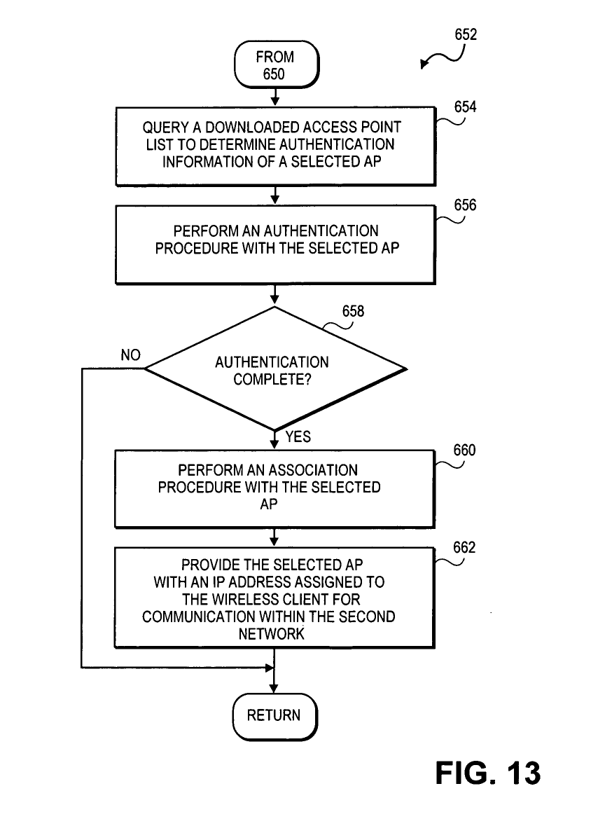

FIG. 13 is a flowchart illustrating a method 652 for establishing a wireless connection to a selected wireless AP of the second network, in accordance with one embodiment of the invention. At process block 654, the wireless station queries a downloaded AP list to determine authentication information of a selected AP. At process block 656, the wireless station performs an authentication procedure with the selected AP. At process block 658, the wireless station determines whether authentication with the selected AP is complete. Once authentication is complete, at process block 660, the wireless station performs an association procedure with the selected AP. At process block 662, the wireless station provides a selected AP with an IP address assigned to the wireless station for communication within the second network.

In an alternative embodiment, MCS server notifies a node of the second network or subnet of the assigned IP address to enable data communication with the second network. Alternatively, DHCP/DRCP server notifies the second network of an IP address assigned to the wireless station. In one embodiment, the IP address is issued for limited duration of time to avoid excessive issuing of new IP address to enable interdomain roaming. Accordingly, in one embodiment, a wireless station including WMM logic described herein provides a user with a continuous wireless connection as the user roams throughout a communications system without requiring any user intervention.

III. Alternate Embodiments

Several aspects of the wireless mobility manager for providing wireless AP handoff and a continuous wireless connection have been described. However, various implementations of the wireless mobility manager provide numerous features including, complementing, supplementing, and/or replacing the features described above. Features can be implemented as part of the wireless station or as part of the AP in different embodiment implementations. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

In addition, although an embodiment described herein is directed to a wireless mobility manager, it will be appreciated by those skilled in the art that the embodiments of the present invention can be applied to other systems. In fact, systems for wireless communication fall within the embodiments of the present invention, as defined by the appended claims. The embodiments described above were chosen and described in order to best explain the principles of the embodiments of the invention and its practical applications. These embodiments were chosen to thereby enable others skilled in the art to best utilize the invention and various embodiments with various modifications as are suited to the particular use contemplated.

Having disclosed exemplary embodiments and the best mode, modifications and variations may be made to the disclosed embodiments while remaining within the scope of the embodiments of the invention as defined by the following claims.

1. A method comprising:
detecting, by a wireless station having a wireless connection to a wireless access point of a first network, movement into a communication range of a second network;
automatically establishing, by the wireless station, a wireless connection with a selected wireless access point of the second network; and
communicating, by the wireless station, via the second network using an assigned IP address.

2. The method according to claim 1, wherein the detecting of movement into the communication range of the second network comprising:
monitoring a current signal strength of the wireless connection to the wireless access point of the first network; and
automatically scanning a current communication range of the wireless station to identify a first group of wireless access points if the current signal strength of the wireless connection falls below a scan threshold.

3. The method according to claim 2, wherein the detecting of movement into the communication range of the second network further comprising:
discontinuing scanning of the current communication range of the wireless station if the current signal strength of the wireless connection rises above the scan threshold.

4. The method according to claim 3, wherein the scan threshold is adjustable by a user of the wireless station.

5. The method according to claim 2, wherein automatically scanning the current communication range of the wireless station, comprising:
downloading an access point list including a second group of wireless access points of the first network and the second network;
comparing the first group of wireless access points to the second group of wireless access points to identify one or more wireless access points as detected wireless access points of the second network;
calculating a signal strength of each detected wireless access point of the second network;
requesting a connection count of each detected wireless access point of the second network; and
calculating bandwidth of each detected wireless access point of the second network.

6. The method according to claim 2, wherein prior to automatically scanning, the method further comprising:
downloading an access point list from a mobile communications server, the access point list containing a list of wireless access points of the first network and the second network;
encrypting the access point list; and
storing the encrypted access point list within the wireless station.

7. The method according to claim 5, wherein comparing the first group of wireless access points to the second group of wireless access points further comprising:
determining an IP address of each wireless access point included within the access point list;
comparing each IP address determined from the access point list to the IP address assigned to the wireless station; and
identifying each wireless access point having a different subnet IP address than the IP address assigned to the wireless station as a wireless access point of the second network.

8. The method according to claim 1, wherein automatically establishing the wireless connection comprising:
identifying one or more wireless access points from a first group of wireless access points detected within the current communication range of the wireless station as identified wireless access points of the second network;
computing a channel quality of each identified wireless access point of the second network according to a signal strength and a capacity of each identified wireless access point of the second network;
computing a quality of service level for each identified access point of the second network according to a respective, computed channel quality and a connection count of each identified access point of the second network; and
selecting an identified wireless access point having a highest quality of service level as the selected access point of the second network.

9. The method according to claim 1, wherein prior to communicating via the second network, the method further comprising:
querying a downloaded access point list to determine the IP address assigned to the wireless station by one of the first network and the second network as the assigned IP address of the wireless station.

10. The method according to claim 9, wherein prior to communicating via the second network, the method further comprising:
requesting assignment of an IP address for communication within the second network from one of the first network and the second network.

11. An article of manufacture including a machine readable medium having stored thereon instructions which may be used to program a wireless station to perform operations, comprising:
detecting, by the wireless station having a wireless connection to a wireless access point of a first network, movement into a communication range of a second network;
automatically establishing, by the wireless station, a wireless connection with a selected wireless access point of the second network; and
communicating, by the wireless station, via the second network using an assigned IP address.

12. The article of manufacture according to claim 11, wherein the detecting of movement into the communication range of the second network comprising:
monitoring a current signal strength of the wireless connection to the wireless access point of the first network; and
automatically scanning a current communication range of the wireless station to identify a first group of wireless access points if the current signal strength of the wireless connection falls below a scan threshold.

13. The article of manufacture according to claim 12, wherein the detecting of movement into the communication range of the second network further comprising:
discontinuing scanning of the current communication range of the wireless station if the current signal strength of the wireless connection rises above the scan threshold.

14. The article of manufacture according to claim 13, wherein the scan threshold is adjustable by a user of the wireless station.

15. The article of manufacture according to claim 12, wherein automatically scanning the current communication range of the wireless station, comprising:
downloading an access point list including a second group of wireless access points of the first network and the second network;
comparing the first group of wireless access points to the second group of wireless access point to identify one or more wireless access points as detected wireless access points of the second network;
calculating a signal strength of each detected wireless access point of the second network;
requesting a connection count of each detected wireless access point of the second network; and
calculating bandwidth of each detected wireless access point of the second network.

16. The article of manufacture according to claim 12, wherein prior to automatically scanning, the operations further comprising:
logging into a mobile communications server;
once authenticated by the mobile communications service, downloading an available access point list from the mobile communications server containing a list of wireless access points of the first network and the second network;
encrypting the available access point list; and
storing the encrypted access point list within the wireless station.

17. The article of manufacture according to claim 13, wherein comparing the first group of wireless access points to the second group of wireless access points further comprising:
determining an IP address of each wireless access point included within the access point list;
comparing each IP address determined from the access point list to the IP address assigned to the wireless station; and
identifying each detected wireless access point having a different subnet IP address than the IP address assigned to the wireless station as a wireless access point of the second network.

18. The article of manufacture according to claim 17, wherein automatically establishing the wireless connection comprising:
identifying one or more wireless access points from a first group of wireless access points detected within the current communication range of the wireless station as identified wireless access points of the second network;
computing a channel quality of each identified access point of the second network according to a signal strength and capacity of each identified wireless access point of the second network;
computing a quality of service level for each identified access point of the second network according to a respective, computed channel quality and a connection count of each identified access point of the second network; and
selecting an identified wireless access point having a highest quality of service level as the selected access point of the second network.

19. The article of manufacture according to claim 11, wherein prior to communicating via the second network, the operations further comprising:
querying a downloaded access point list to determine the IP address assigned to the wireless station by one of the first network and the second network.

20. The article of manufacture according to claim 19, wherein prior to communicating via the second network, the operations further comprising:
requesting assignment of an IP address for communication within the second network from one of the first network and the second network as the assigned IP address of the wireless station.

21. A method comprising:
automatically scanning a current communication range of a wireless station to identify a first group of wireless access points if a signal quality parameter of a current wireless connection to a wireless access point falls below a scan threshold; and
automatically establishing a wireless connection with a selected wireless access point from the first group of wireless access points if the signal quality parameter of the current wireless connection falls below a switch threshold.

22. The method according to claim 21, wherein the signal quality parameter is a signal strength of the current wireless connection.

23. The method according to claim 21, wherein at least one of the scan threshold and the switch threshold is programmable by the user.

24. The method according to claim 22, wherein automatically establishing the wireless connection comprising:
determining a signal strength of each wireless access point from the first group of wireless access points; and
selecting a wireless access point from the first group of wireless access points having a highest signal strength.

25. The method according to claim 22, wherein automatically scanning further comprising:
discontinuing scanning of the current communication range of the wireless station if the current signal strength of the current wireless connection rises above the user selected scan threshold.

26. The method according to claim 22, wherein automatically establishing the wireless connection comprising:
requesting a connection count for each wireless access points from the first group of wireless access points; and
selecting a wireless access point from the first group of wireless access points having a lowest connection count.

27. The method according to claim 22, wherein automatically establishing the wireless connection with the selected wireless access point comprising:
determining a signal-to-noise ratio of each wireless access points from the first group of wireless access points; and
selecting a wireless access point from the first group of wireless access points having a lowest signal-to-noise ratio.

28. The method according to claim 22, wherein automatically establishing a wireless connection with the selected access point comprising:
determining a bit error rate of each wireless access points from the first group of wireless access points; and
selecting a wireless access point from the first group of wireless access points having a lowest bit error rate.

29. The method according to claim 22, wherein automatically establishing the wireless connection with the selected access point comprising:
requesting pre-allocation of a predetermined network bandwidth from a wireless access point of the first group of wireless access points;
receiving, from a quality of service application, designation of a wireless access point from the group of wireless access points, wherein the requested bandwidth allocation is pre-allocated; and
selecting the designated wireless access point in order to establish a wireless connection with the designated wireless access point.

30. The method according to claim 22, wherein automatically scanning further comprising:
computing a ratio of a previous signal strength to a current signal strength; and
scanning the current communication range when the ratio is less than or equal to a user selected scan ratio.

31. The method according to claim 22, wherein automatically establishing the wireless connection further comprising:
downloading an access point list including a second group of wireless access points;
comparing the first group of wireless access points to the second group of wireless access points to identify one or more of the detected wireless access points to which a user of the wireless station has authorized access; and
selecting a wireless points from the one or more detected wireless access points in order to establish an authorized, wireless connection with the selected wireless access point.

32. The method according to claim 22, wherein automatically scanning the current communication range further comprising:
determining one or more interfaces of the wireless station;
scanning the current communication range of the wireless station to identify wireless access points supporting an interface of the wireless station; and
selecting a wireless access point from the identified wireless access points based on a user order of preference among the interfaces of the wireless station.

33. An article of manufacture including a machine readable medium having stored thereon instructions which may be used to program a wireless station to perform operations, comprising:
automatically scanning a current communication range of the wireless station to identify a first group of wireless access points if a current signal strength of a current wireless connection to a wireless access point falls below a user selected scan threshold; and
automatically establishing a wireless connection with a selected wireless access point from the first group of wireless access points if the current signal strength of the current wireless connection falls below a user selected switch threshold.

34. The article according to manufacture claim 33, wherein automatically establishing a wireless connection comprising:
determining a signal strength of each wireless access points from the first group of wireless access points; and
selecting a wireless access point from the first group of wireless access points having a highest signal strength.

35. The article of manufacture according to claim 33, wherein automatically scanning further comprising:
discontinuing scanning of the current communication range of the wireless station if the current signal strength of the current wireless connection rises above the user selected scan threshold.

36. The article of manufacture according to claim 33, wherein automatically establishing the wireless connection further comprising:
requesting a connection count for each wireless access point from the first group of wireless access points; and
selecting a wireless access point from the first group of wireless access points having a lowest connection count.

37. The article of manufacture according to claim 35, wherein establishing a wireless connection with the selected access point further comprising:
determining a signal-to-noise ratio of each wireless access point from the first group of wireless access points; and
selecting a wireless access point from the first group of wireless access points having a lowest signal-to-noise ratio.

38. The article of manufacture according to claim 33, wherein establishing a wireless connection with the selected access point further comprising:
determining a bit error rate of each wireless access point from the first group of wireless access points; and
selecting a wireless access point from the first group of wireless access points having a lowest bit error rate.

39. The article of manufacture according to claim 33, wherein establishing the wireless connection with the selected access point further comprising:
requesting pre-allocation of a predetermined network bandwidth from a wireless access point of the first group of wireless access points;
receiving, from a quality of service application, designation of a wireless access point from the first group of wireless access points, wherein the requested bandwidth allocation is pre-allocated; and
selecting the designated wireless access point in order to establish a wireless connection with the designated wireless access point.

40. The article of manufacture according to claim 33, wherein automatically scanning further comprising:
computing a ratio of a previous signal strength to the current signal strength; and
scanning the current communication range when the ratio is less than or equal to a user selected scan ratio.

41. The article of manufacture according to claim 33, wherein establishing the wireless connection further comprising:
downloading access point list including a second group of wireless access points;
comparing the first group of wireless access points to the second group of wireless access points to identify one or more of the detected wireless access points to which a user of the wireless station has authorized access; and
selecting a wireless points from the one or more detected wireless access points in order to establish an authorized wireless connection with the selected, wireless access point.

42. The article of manufacture according to claim 33, wherein automatically scanning the current communication range further comprising:
determining one or more interfaces of the wireless station;
scanning the communication range of the wireless station to identify wireless access points supporting an interface of the wireless station; and
selecting a wireless access point from the one or more identified wireless access points based on a user order of preference among the interfaces of the wireless station.

43. A wireless station comprising:
a communications interface to establish a current wireless connection to a wireless access point; and
circuitry coupled to the communications interface, the circuitry comprising logic to cause an automatic scan of a current communication range of the wireless station to identify a first group of wireless access points if a signal strength of the current wireless connection falls below a user selected scan threshold and to cause the automatic establishment of a wireless connection with a selected access point from the first group of wireless access points if the signal strength of the current wireless connection falls below a user selected switch threshold.

44. The wireless station according to claim 43, wherein the logic comprises:
access point handoff logic to cause identification of one or more wireless access from the first group of wireless access points as identified wireless access points of the second network, to cause computation of a channel quality of each identified wireless access point according to a signal strength, and a bandwidth of each identified wireless access point, to cause computation of a quality of service level for each identified wireless access point according to a respective, computed channel quality and a connection count of each identified wireless access point and to cause selection of an identified wireless access point having a highest quality of service level.

45. The wireless station according to claim 43, wherein the logic comprises:
access point scan logic to cause monitoring of the current signal strength of the current wireless connection and to cause discontinuation of the scan of the current communication range if the current signal strength of the current wireless connection rises above the user selected scan threshold.

46. The wireless station according to claim 43, wherein the logic comprises:
access point switch logic to cause a downloading of an access point list including a second group of wireless access points, to cause a comparison of the first group of wireless access points to the second group of wireless access points to identify one or more detected wireless access points to which the user of the wireless station has authorized access, and to cause a selection of a wireless points from the one or more detected wireless access points in order to establish an authorized wireless connection with the selected wireless access point.

47. The wireless station according to claim 43, wherein the logic comprises:
QoS logic to cause a request of pre-allocation of a predetermined network bandwidth from a wireless access point of the first group of wireless access points, to cause a receipt, from a quality of service application, a designation of a wireless access point from the first group of wireless access points, wherein the requested bandwidth allocation is pre-allocated and to cause a selection of the designated wireless access point in order to establish a wireless connection with the designated wireless access point.

48. A system comprising:
a first subnet, including a first node server and at least one first access point in communication with the first node server; and
a wireless station comprising:
a communications interface to establish a wireless connection with the first wireless access point of the first subnet; and
circuitry coupled to the communications interface, the circuitry comprising logic to cause an automatic scan of a current communication range of the wireless station to identify a first group of wireless access points of the first subnet if a signal strength of the wireless connection to the first wireless access point falls below a user selected scan threshold and to cause automatic establishment of a wireless connection with a selected wireless access point from the first group of wireless access points if the current signal strength falls below a user selected switch threshold.

49. The system according to claim 48, further comprising:
a second subnet including a second node server and at least one second wireless access point in communication with the second node server;
wherein, the wireless station to roam into communication range of the second subnet while having the wireless connection to the first wireless access point of the first subnet and to automatically establish a wireless connection with the second wireless access point of the second subnet.

50. The system according to claim 48, further comprising:
a server to cause allocation of a temporary IP address to the wireless station to enable data communication within the second subnet.

51. The system according to claim 48, further comprising:
a server to cause a login authentication of the wireless station in response to a login request and to cause transmission of a wireless access point list to the wireless station containing a list of wireless access points of the first network and the second network.

52. The system according to claim 48, further comprising:
a server to cause pre-allocation of a predetermined network bandwidth within a designated wireless access point from the first group of wireless access points in response to an allocation request and to cause notification of the designated wireless access point to the wireless station, wherein the requested bandwidth allocation is pre-allocated.
